(19) United States
(12) Patent Application Publication
(10) Pub. No.: US 2010/0124733 A1
(43) Pub. Date: May 20, 2010

(54) Educational word game

(76) Inventor: Laura A. Stevens, Chantilly, VA (US)

Correspondence Address: WELSH & FLAXMAN LLC, 2000 DUKE STREET, SUITE 100, ALEXANDRIA, VA, 22314, US

(21) Appl. No.: 12/382,774

(22) Filed: Mar. 24, 2009

Related U.S. Application Data
(60) Provisional application No. 61/199,270, filed on Nov. 16, 2008.

(51) Int. Cl. G09B 1/00; G09B 3/02; A63F 1/00

(52) U.S. Cl. 434/172; 434/176; 273/299

(57) ABSTRACT

An educational word game includes a plurality of answer pads. Each of the answer pads includes a first column composed of a plurality of short lines on which selected word fragments are written and a second column composed of a plurality of long lines on which players' answers are written next to the first column of the plurality of short lines creating distinct rows. The game further includes a plurality of writing implements, a timer, and a plurality of playing cards. Each of the playing cards includes a backside identical to the backside of all other playing cards and a front side printed with a word fragment used in playing the present word. The game is played by providing each player with an answer pad and a writing implement; selecting playing cards having word fragments printed thereon; recording the word fragments from the playing cards on the answer pad; forming words including the word fragments; and comparing the words and awarding points.

### CROSS REFERENCE TO RELATED APPLICATION

This application claims the benefit of U.S. Provisional Patent Application Ser. No. 61/199,270, filed Nov. 16, 2008, entitled “EDUCATIONAL WORD GAME”.

### BACKGROUND OF THE INVENTION

1. Field of the Invention

The invention relates to word games. More particularly, the invention relates to games of education through play.

2. Description of the Related Art

A wide variety of board games have been developed and are well known to the public at large, as well as those intimately involved in the board game industry. These games provide hours of amusement, while oftentimes helping us develop our mental abilities. Whether the games are strategy based, trivia oriented, or educationally directed, those playing the games develop a bond with those with whom they are playing while learning about their opponents and the world at large.

As such, board games offer new avenues for interaction and learning, and there continues to be a need for games which further these goals.

### SUMMARY OF THE INVENTION

It is, therefore, an object of the present invention to provide an educational word game including a plurality of answer pads. Each of the answer pads includes a first column composed of a plurality of short lines on which selected word fragments are written and a second column composed of a plurality of long lines on which players' answers are written next to the first column of the plurality of short lines creating distinct rows. The word game also includes a plurality of writing implements, a timer, and a plurality of playing cards. Each of the playing cards includes a backside identical to the backside of all other playing cards and a front side printed with a word fragment used in playing the present word.

It is also an object of the present invention to provide a word game wherein ten rows of short lines and long lines are printed upon the answer pad.

It is another object of the present invention to provide a word game wherein the answer pad includes answer sheets printed with the respective short lines and long lines.

It is a further object of the present invention to provide a word game including bi-fold folders in which the answer pads are stored.

It is also an object of the present invention to provide a word game wherein the fragments are selected from the group consisting of FY, ANCE, CY, ANTI, SUB, CAL, MIS, REP, PHE, PRE, TION, DEM, GRAPH, IC, IAN and EX.

It is another object of the present invention to provide a method for playing an educational word game. The method is achieved by providing each player with an answer pad and a writing implement, selecting playing cards having word fragments printed thereon, recording the word fragments from the playing cards on the answer pad, forming words including the word fragments, and comparing the words and awarding points.

It is a further object of the present invention to provide a method for playing an educational word game wherein the answer pad includes a first column composed of a plurality of short lines on which selected word fragments are written and a second column composed of a plurality of long lines next to the first column of the plurality of short lines creating distinct rows.

It is also an object of the present invention to provide a method for playing an educational word game wherein each of the answer pad includes answer sheets printed with the respective short lines and long lines.

It is another object of the present invention to provide a method for playing an educational word game wherein each of the playing cards includes a back side identical to the back side of all other playing cards and a front side printed with the word fragment used in playing the present word.

It is a further object of the present invention to provide a method for playing an educational word game wherein points are awarded based upon the number of syllables in the words formed during play of the present word game.

It is also an object of the present invention to provide a method for playing an educational word game wherein the step of forming is limited by time.

It is another object of the present invention to provide a method for playing an educational word game wherein the word fragments are selected from the group consisting of FY, ANCE, CY, ANTI, SUB, CAL, MIS, REP, PHE, PRE, TION, DEM, GRAPH, IC, IAN and EX.

It is a further object of the present invention to provide a method for playing an educational word game wherein players take turns selecting playing cards and sharing the word fragment printed thereon for the players to then record on the answer pads.

It is also an object of the present invention to provide a method for playing an educational word game wherein players are only awarded points when the word they have listed is different from any other word listed by another player.

Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a perspective view of the word game in accordance with the present invention.

FIG. 2 is a detailed view of the folder, answer pad and writing implement in accordance with the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as a basis for teaching one skilled in the art how to use the invention.

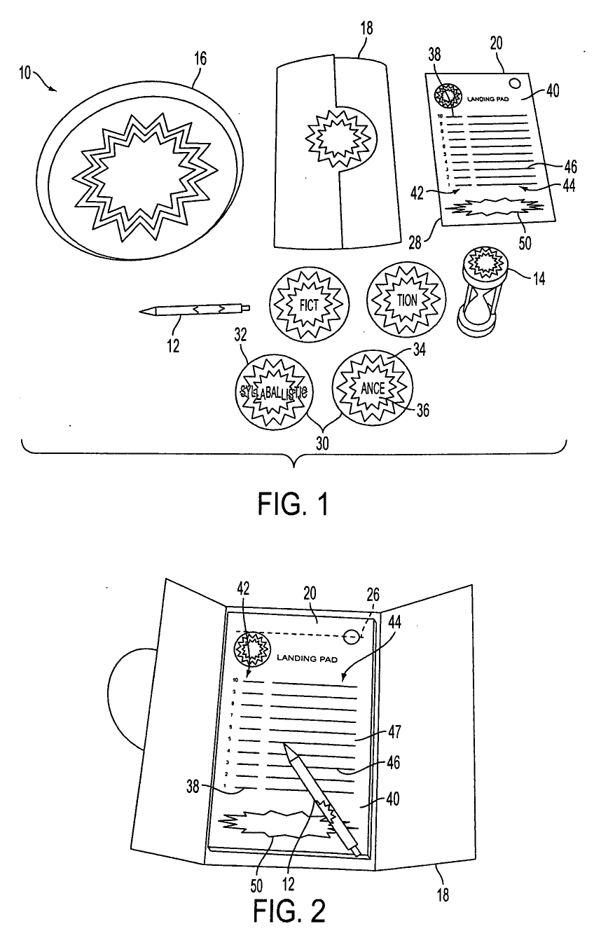

In accordance with the present invention and with reference to FIGS. 1 and 2, an educational word game 10 is disclosed. The word game 10 revolves around the formation of complete words incorporating preselected fragments. By forming complete words in the manner discussed below in greater detail, players accumulate as many points as possible, and the player having the greatest number of points at the end of the game (after a certain predetermined number of rounds) is named the winner.

The present educational word game 10 uses word fragments to stimulate, improve and/or enlarge a player's vocabulary, pronunciation, and spelling in a challenging, competitive, fast paced, and fun manner. As those skilled in the art will appreciate, the present word game 10 may be played in a variety of languages, including, but not limited to, English, French, German, and Spanish.

As will be discussed below in greater detail and further appreciated based upon the following disclosure, the present educational word game 10:
uses word fragments rather than individual letters or whole words or phrases;
points are scored based upon using an indicated and respective word fragment to create polysyllable words, rather than individual letters, and earning one point per syllable;
players are limited by time and the required use of the indicated word fragment in their word/answer; and
players have no limit as to the length of their word/answer.

Briefly, and as discussed below in greater detail, after the players are provided with writing implements 12 various word fragments are selected and the players record each word fragment. A timer 14 is set in a position between the various players and when inverted (or otherwise started), play begins. Players have three minutes to form words containing the corresponding word fragments. Although a three minute time limit is contemplated for use in accordance with a preferred embodiment of the invention, other time limits may be set based upon the desires of those playing the game. The players then compare their words and accumulate points based upon the number of syllables for acceptable words that do not match any other player's word. The player with the highest cumulative score after four rounds of play is declared the winner of the game.

The concepts embodied in the present game encourage vocabulary building by requiring players to think of words that contain the selected word fragment and, in comparing word/answers, players can learn words to add to their vocabulary. The present word game 10 encourages improved spelling through correct usage of the individual word fragments; for example, by using the fragment “ance” in the word “appearance”, the player is taught the word is properly spelled “APPEARANCE” as opposed to “APPEARENCE”.

The present word game 10 encourages improved understanding of pronunciation in the player's correct division of a word-answer's syllables. The game 10 can be played with as few as a single player, sharpening and challenging himself or herself in vocabulary, spelling and pronunciation, or with a limitless number of players or teams. The present word game 10 can be played according to an agreed upon field, subject, or rule; for example, the players may agree to limit the allowable word answers strictly of the field of law, or of medicine, of the subject of sports, or of entertainment, or of contrived fad words. Similarly, the players may mutually agree to limit allowable words to a particular word size, for example, only words composed of five syllables are acceptable. The present word game 10 can also be used as a learning tool in the school classroom and can be adapted to any age group; and with rule modifications, can be played with mixed age groups. The present word game 10 can be used in senior centers to stimulate brain activity, socialization, and entertainment of its residents. The present word game 10 is portable and can be adapted to any size, shape and form including but not limited to electronic or Internet play.

Referring to the various figures the components used in conjunction with the present word game 10 are shown. In accordance with a preferred embodiment, the present word game 10 only requires six (6) game components. FIG. 1 shows the preferred plan view of the game 10 in play. Briefly, and as will be further appreciated based upon the detailed explanation of game play as discussed below, the present word game 10 includes a game board composed of large disk 16. The present word game 10 also includes a plurality of bi-fold folders 18 each containing an answer pad 20; in accordance with a preferred embodiment, five (5) bi-fold folders 18 with five (5) answer pads 20 are provided. The answer pads 20 may be referred to as “Landing Pad”.

The bi-fold folders 18 are preferably constructed with retaining pockets 26 in which the cardboard supporting back 28 of the respective answer pads 20 may be positioned for selectively holding, supporting and replacing the answer pads 20 within the bi-fold folders 18. Although a preferred folder is disclosed herein in accordance with a preferred embodiment of the present invention, other folder constructions are contemplated for use in accordance with the present invention without departing from the spirit of the present invention.

The word game 10 also includes a plurality of writing implements, for example, five (5) pencils 12, a timer 14, for example, a 3-minute hourglass timer. Although a three minute hourglass timer is disclosed in accordance with a preferred embodiment of the present invention, it is contemplated other time limits may be established and other timer devices may be employed.

In addition to the components discussed above, the word game 10 also includes a plurality of playing cards 30. Each of the playing cards 30 includes a back side 32 which is identical to the back side 32 of all other cards 30 to ensure randomness as players pick cards in accordance with the procedures of the present word game 10. The front sides 34 of the various cards 30 are printed with word fragments 36 used by the players in determining the word fragments 36 used during each round of the game. Exemplary word fragments include: FY, ANCE, CY, ANTI, SUB, CAL, MIS, REP, PHE, PRE, TION, DEM, GRAPH, IC, IAN and EX.

The game 10 is played in four rounds as follows. Each player is provided with one bi-fold folder 18 containing one answer pad 20 and a pencil 14. The playing cards 30, seventy-five (75) in number in accordance with a preferred embodiment of the present invention, are placed face downward upon the large disk 16 which is set in a centrally located position among the players participating in the game 10. Although seventy-five cards are contemplated for use in accordance with a preferred embodiment, more or less cards may be used without departing from the spirit of the present invention. Each player takes a turn selecting a playing card 30 and sharing the word fragment 36 indicated on the face, or front side 34, of the card with the other players. The players assign, that is, record each word fragment 36 in the order selected on the short line 38 of their answer pad-sheet 40 until all of the short lines are filled (there are ten short lines in accordance with a preferred embodiment of the present invention). While ten short lines are disclosed in accordance with a preferred embodiment, the number of lines may be varied and those playing the game may agree to use a limited number of lines if they determine it will improve play for their group.

The answer pad 20 includes printed answer sheets 40 to facilitate game play in a controlled manner. More particularly, each answer sheet 40 includes a first column 42 composed of ten (10) short lines 38. The selected word fragments are written on these lines 38. A second column 44 of lines 46 is printed next to the first column 42 of short lines 38, creating ten (10) distinct rows 47. The second column 44 of lines 46 are longer than the first column 42 of lines 38 since words/answers are to be written upon the lines 46 of the second column 44.

The timer 14 is set in a central location among the players and when the timer is inverted play begins. Players have three minutes to form words containing the corresponding word fragment 36 and the words/answers are written on the lines 46 of the second column 44 adjacent to the related word fragment 36. The fragment may appear anywhere in the word. When the timer runs out, players must immediately cease writing. Players, in turn, compare their words with each other aloud beginning with the word listed on the tenth row 47 of the short lines 38 and the long lines 46. Each player corrects his or her own answers by circling an acceptable word that does not match any other players' word; that is, players only are awarded points when the word they have listed is different from any other word listed by another player on the same row. Players score one point for each syllable in their acceptable words and record their total score for each round in the circle at the top of their answer sheet. The player with the highest cumulative score after four rounds of play is declared the winner of the game.

In accordance with the rules of the present game, which may be varied as discussed above with the agreement of all players,
all words must contain the indicated word fragment;
players are not permitted to repeat a word on different rows in any one round;
proper nouns are acceptable;
accents and other grammar marks, except hyphens, are acceptable; and
bluffing is acceptable but players are subject to a challenge.

Bluffing may result in a challenge. More particularly, while comparing answers, another player—the first to call it—may challenge the legitimacy of an opponent's word. If the word is legitimate the challenger loses five points and the opponent gains five points. If the word is not legitimate the challenger gains five points and the opponent loses five points. A dictionary showing syllable division is to be used to settle disputes among players.

Extra points may be awarded to players where,
the syllable count of a word-answer is doubled if the indicated word fragment appears twice in that word/answer; and
players can enter a word of their choosing into the graphic 50 at the bottom of their answer sheet, which I have designated the SYLLABALLISTIC BUBBLE™. The word can and should contain as many syllables as possible and the player receives points based upon the number of syllable contained therein.

In accordance with the spirit of the present word game it is contemplated the game may be varied as follows.
All players agreeing upon a specific field or subject, for example: medicine, sports, or food. When the game is varied in this manner, all answers must be related to the selected field or subject. This variation is designated as “SYLLECTION™”.
All players agreeing upon a particular celebrity and only words related to or describing this celebrity are acceptable. This variation has been designated as “SYLLEBRITY™”.
All players agreeing upon a target limit of syllables for a round of play, for example: only three syllable words or only six syllable words. Scoring is one point per word with no player's words matching. This variation has been designated as “SYLLIMITS™”.
All players agreeing upon only silly, slang, and fad words that are not found in a dictionary are acceptable. This variation has been designated as “SYLLYABLES™”.

In all the above described and designated variations, the aforementioned game play remains the same unless otherwise indicated.

In practice, rules are provided with the word game 10. In accordance with a preferred embodiment, the rules are as follows:
All players take a folder containing a LANDING PAD, and a pencil.
One player is chosen to shuffle and spread all 75 cards face down on the center disk. In clockwise fashion, each player takes a turn selecting a card and sharing the word fragment indicated on the face with the other players. All players assign each word fragment in the same order on the short line of their LANDING PAD until all numbers (1-10) are assigned.
The timer is inverted and play begins.
Players have 3 minutes to form words containing the corresponding word fragment. The fragment may appear anywhere in the word (see SAMPLE #1).
When the timer runs out, players must immediately cease writing.
How to score a round: Players, in turn compare their words with each other aloud beginning with number 10. Each player corrects his or her own answers by circling an acceptable word that DOES NOT match any other players' word. Players score 1 point for each syllable in their word and record their total score for each round in the circle at the top of their PAD (see SAMPLE #2 and ACCEPTABLE ANSWERS).
ACCEPTABLE ANSWERS: Proper nouns and words with accents or other grammar marks, except hyphens, are acceptable. Bluffing is allowed, but you are subject to a challenge by another player (see CHALLENGING). Players are not permitted to repeat a word in any one round. For example, a player cannot answer intuition for the word fragment “in” and also for the word fragment “tion” (see SAMPLE #2).
EXTRA POINTS: The syllable count of a word-answer is doubled if the indicated word fragment appears twice in that word. For example, or, orator [or-a-tor] has 3 syllables but counts as 6 points. Extra points are earned when a player blasts a mega-syllable word of their choosing in the ballistic bubble at the bottom of the LANDING PAD. The word may contain as many syllables as possible. Scoring remains the same.
CHALLENGING: A word can be challenged by only one player—the first to call it. While a word is being read, another player may challenge its legitimacy. If the word is legitimate, the challenger loses 5 points and the challengee gains 5 points. If the word is not legitimate, the challenger gains 5 points and the challengee loses 5 points.
GAME VARIATIONS: Syllebrity—a particular celebrity is agreed upon by all players and only words related to or describing this celebrity are acceptable. Scoring remains the same. Syllection—a specific field or subject is selected and agreed upon by all players, for example, sports or food or law. All answers must be related to the selected subject. Scoring remains the same. Sillyables—only silly, slang and fad words which are NOT found in a standard dictionary are acceptable. Scoring remains the same. Syllimits—a target limit of syllables for a round of play is agreed upon, for example, only one syllable words or only six syllable words. Scoring is 1 point per word with no players' words matching.

While the preferred embodiments have been shown and described, it will be understood that there is no intent to limit the invention by such disclosure, but rather, is intended to cover all modifications and alternate constructions falling within the spirit and scope of the invention.

1. An educational word game, comprising:
a plurality of answer pads, each of the answer pads includes a first column composed of a plurality of short lines on which selected word fragments are written and a second column composed of a plurality of long lines on which players' answers are written next to the first column of the plurality of short lines creating distinct rows;
a plurality of writing implements;
a timer; and
a plurality of playing cards, each of the playing cards includes a backside identical to the backside of all other playing cards and a front side printed with a word fragment used in playing the present word.

2. The word game according to claim 1, wherein ten rows of short lines and long lines are printed upon the answer pad.

3. The word game according to claim 1, wherein the answer pad includes answer sheets printed with the respective short lines and long lines.

4. The word game according to claim 1, further including bi-fold folders in which the answer pads are stored.

5. The word game according to claim 1, wherein the fragments are selected from the group consisting of FY, ANCE, CY, ANTI, SUB, CAL, MIS, REP, PHE, PRE, TION, DEM, GRAPH, IC, IAN and EX.

6. A method for playing an educational word game, comprising:
providing each player with an answer pad and a writing implement;
selecting playing cards having word fragments printed thereon;
recording the word fragments from the playing cards on the answer pad;
forming words including the word fragments; and
comparing the words and awarding points.

7. The method according to claim 6, wherein the answer pad includes a first column composed of a plurality of short lines on which selected word fragments are written and a second column composed of a plurality of long lines on which players' answers are written next to the first column of the plurality of short lines creating distinct rows.

8. The method according to claim 7, wherein each of the answer pads include answer sheets printed with the respective short lines and long lines.

9. The method according to claim 6, wherein each of the playing cards includes a backside identical to the backside of all other playing cards and a front side printed with the word fragment used in playing the present word.

10. The method according to claim 6, wherein points are awarded based upon the number of syllables in the words formed during play of the present word game.

11. The method according to claim 6, wherein the step of forming words is limited by time.

12. The method according to claim 6, wherein the word fragments are selected from the group consisting of FY, ANCE, CY, ANTI, SUB, CAL, MIS, REP, PHE, PRE, TION, DEM, GRAPH, IC, IAN and EX.

13. The word game according to claim 6, wherein players take turns selecting playing cards and sharing the word fragment printed thereon for the players to then record on the answer pads.

14. The word game according to claim 6, wherein players are only awarded points when the word they have listed is different from any other word listed by another player.
